(19) United States
(12) Patent Application Publication
(10) Pub. No.: US 2017/0043520 A1
(43) Pub. Date: Feb. 16, 2017

(54) METHODS FOR LAYER MULTIPLICATION CO-EXTRUSION OF HIGH VISCOUS POLYMERIC MATERIAL SYSTEMS

(71) Applicants: CASE WESTERN RESERVE UNIVERSITY, CLEVLAND, OH (US); THE GOODYEAR TIRE & RUBBER COMPANY, AKRON, OH (US)

(72) Inventors: Joao M. Maia, Shaker Heights, OH (US); Patrick J. Harris, Cleveland Heights, OH (US); Gary Burg, Pawleys Island, NC (US)

(73) Assignee: CASE WESTERN RESERVE UNIVERSITY, CLEVELAND, OH (US)

(21) Appl. No.: 15/307,191

(22) PCT Filed: Apr. 28, 2015
(86) PCT No.: PCT/US15/27941

§ 371 Date: Oct. 27, 2016

Related U.S. Application Data
(60) Provisional application No. 61/985,038, filed on Apr. 28, 2014.

(51) Int. Cl. B29C 47/06

(52) U.S. Cl. CPC B29C 47/06; B29L 2009/00

(57) ABSTRACT

Methods for co-extruding multiple layers of materials, in particular high viscosity elastomer materials, wherein the method allows the use of either rheologically matched or unmatched elastomers. Devices for practicing the methods are disclosed. Multilayer extrudates exhibiting desirable performance can be formed from materials including high and/or low viscosity elastomers.

### CROSS REFERENCE

This application is a conversion application of U.S. patent application No. 61/985,038, filed Apr. 28, 2014, for “Methods for Layer Multiplication Co-Extrusion of High Viscous Elastomer Polymeric Systems”, which is hereby fully incorporated by reference.

### FIELD OF THE INVENTION

The present invention relates to methods for co-extruding multiple layers of materials, in particular high viscosity polymeric materials, wherein the methods allow the use of either rheologically matched or unmatched materials or elastomers. Devices for practicing the methods are disclosed. Multilayer extrudates exhibiting desirable properties can be formed from materials including high and/or low viscosity elastomers.

### BACKGROUND OF THE INVENTION

Plastics co-extrusion is a manufacturing process in which two or more polymers feed a common die system to form a single product. This single product typically contains a layered section consisting of one or more different materials. After leaving the extruders, the materials meet in a feedblock and are allowed to flow together into the multiplication die packs. Co-extrusion has the unique advantage of producing a composite material with the combined thermal, electrical, barrier, and/or mechanical properties of the constituent materials, see H. Harris, Extrusion Control: Machine, Process, Product; Hanser Publishers (2004) and C. Rauwendal, Polymer Extrusion, Hanser Publishers, Munich (1986). The final properties derived from a product are strongly dependent upon its structure; structure and property are likewise dependent upon the processing of the material, see C. I. Chung, Extrusion of Polymers: Theory and Practice, 2nd Edition, Hanser Publishers (2011).

The development of co-extrusion was first performed in the early 1930s by the Wingfoot Corporation when they joined two unvulcanized rubber materials in a feedblock, similar to the process previously described, see R. W. Snyder et al. U.S. Pat. No. 1,952,469 (1934). Later, D. N. Lehman described a co-extrusion process for joining tire tread and side wall rubber together, see P. W. Lehman et al. U.S. Pat. No. 2,096,362 (1937). Companies such as the U.S. Rubber Company, B.F. Goodrich Company, Goodyear Tire and Rubber Company, and Bridgestone Tire Company, all followed suit in developing novel concepts to join several unvulcanized rubber materials for the manufacturing of rubber goods, see J. L. White, Rubber Processing, Technology, Materials, and Principles, Hanser, 419-425 (1995).

Co-extrusion research and manufacturing accelerated in the thermoplastics industry beginning in the 1960's when the Dow Chemical Company developed multilayer co-extrusion system, see P. Anderson, et al., App. Rheo., 16, 198-205 (2006). Currently, research is on-going at the Center for Layered Polymeric Systems (CLIPS) at Case Western Reserve University. Limited-to-non-existent research has been performed in the multilayer co-extrusion of unvulcanized rubber.

Multilayer co-extrusion differs from standard co-extrusion in that, directly following the combining flow in the feedblock, the materials are fed through a layer multiplying extrusion die system wherein the layers are multiplied by a factor of 2. The multiplication factor is dependent upon the geometry of the multiplication die system. In one embodiment two extruders are used and feed the two polymeric materials into a feed block. Assuming 10 die packs are attached to the outflow of the feed block system; and each die pack doubles the amount of layers fed in; the polymeric layered product will contain 1,024 total horizontal layers.

Although multilayer co-extrusion capably produces materials with interesting properties, it is very susceptible to the presence of flow instabilities and non-uniformities during manufacturing. Previous studies have shown layer non-uniformities in both material composition as well as cross-section, see P. Harris, et. al. Polymer Engineering and Science., (10.1002/pen. 23597) (2013). Several material properties adversely affect the flow pattern which causes these non-uniformities; the most important of these, viscous encapsulation, see J. Dooley, “Viscoelastic Flow Effects in Multilayer Polymer Co-extrusion”, Eindhoven Univ. of Technology, Thesis (2002), S. Hatzikiriakos, et. al. Polymer Processing Instabilities: Control and Understanding, Marcel Dekker (2005), and A. Torres., et al., Rheol Acta, 32, 513-525 (1993). Similarly, elastic rearrangement adversely affects the uniform cross-section, see S. Hatzikiriakos, et. al. Polymer Processing Instabilities: Control and Understanding, Marcel Dekker (2005), and A. Torres., et al., Rheol Acta, 32, 513-525 (1993). Viscous encapsulation is the tendency of a material with a relatively lower viscosity to encapsulate a material with a relatively higher viscosity, see S. Hatzikiriakos, et. al. Polymer Processing Instabilities: Control and Understanding, Marcel Dekker (2005), and A. Torres., et al., Rheol Acta, 32, 513-525 (1993). This phenomenon has been widely investigated, as exemplified by the extensive and systematic work of Joseph Dooley see S. Hatzikiriakos, et. al. Polymer Processing Instabilities: Control and Understanding, Marcel Dekker (2005). Similarity, when secondary flow patterns exist due to high second normal stress differences, elastic rearrangement of the melt is possible. This rearrangement of the melt stream has a direct effect on the outcome of layer structure and quality.

The primary advantage of this process is in the ability to join several materials, each containing their own unique properties; to form a layered product which contains the properties of the individual components. At times, synergistic effects can arise from the combination of different materials; e.g. combining two materials with a mediocre relative tensile strength may form excellent tensile properties once the materials are layered. Another example was discovered recently and has been termed as ‘confined crystallization’. Briefly, some polymeric materials once cooled after being heated form crystallinity, anywhere from lightly crystallized at 0-10% crystalline; up to as much as 90-95% crystalline. The crystal structure is due to the polymeric chains packing into small domains. When a crystalline material is melted above it melting temperature, it can be extruded and thus, multilayer co-extruded. When the once crystalline material is layered to a thickness of <20 nanometers, then allowed to cool; the kinetics of the chain packing and crystallinity are novel and unique. Advantages from confined crystallization are an increase of several properties such as gas barrier, moisture barrier, and tensile strength; among others.

The primary disadvantage currently in the multilayer co-extrusion process is the ability to layer polymeric materials which are of low viscosity such as particular polyesters (e.g. liquid crystalline polymers) and high viscosity polymers such as elastomers, some thermosets, and thermoplastic elastomers. For the purpose of this disclosure, these materials are placed into an overall subset of elastomers, hence forth polymeric materials. The overall disadvantage of the current process noted above in regards to the high viscosity materials develops from the lack of pressure which can be developed prior to the feedblock and layer multipliers. That is, the extruder/gear pump system which forces the material into the feedblock and layer multipliers typically has 5,000 pounds per square inch of available pressure. This amount of pressure is severely low and incapable of forcing high viscosity material through a long multilayer co-extrusion process. There is a huge need for a system to be developed for high viscosity elastomers.

### SUMMARY OF THE INVENTION

In view of the above it is an object of the present invention to provide a multilayer co-extrusion process for materials, in particular high viscosity elastomer materials.

Another object of the present invention is to provide a multilayer co-extrusion system utilizing a multiplying die pack that multiplies a layer by a factor of 3 or 4 or more and provides a smaller total stack length which ultimately results in a reduced pressure drop.

A further object of the present invention is to provide a multilayer co-extrusion system including a roller die that pulls on a multilayered material received from a die pack, thereby relieving pressure built up in the system and also shaping the final profile.

A method for co-extruding multiple layers of a polymeric material, comprising the steps of: providing a plurality of cold polymeric materials; providing at least two extruders, each said extruder, independently, receiving said polymeric materials and extruding said polymeric material, independently, at a temperature of less than about 300° C.; providing a gear pump for each said extruded polymeric materials and, independently, applying high pressure to each said extrudate; providing a feedblock for each said gear pump for receiving said pressurized polymeric material, each said feedblock, independently, connected to a multiplier die pack system comprising a series of one or more said die packs, each said multiplier die pack, independently, capable of dividing said polymeric material into a plurality of layers; providing a roller die for receiving said plurality of multiple layers from each said die pack and, independently, pulling said plurality of multiple layers from said roller; and combining said multiple layers from said die packs and forming a profile of said extrudates.

A system for co-extruding multiple layers of a polymeric material, comprising: a plurality of cold polymeric materials; at least two extruders, each said extruder, independently, capable of receiving said polymeric materials and, independently, extruding said polymeric materials at a temperature of less than about 300° C.; a gear pump for each said extruded polymeric material, each said gear pump capable of, independently, applying high pressure to said extruded polymeric material; a feedblock for each said gear pump for receiving said pressurized polymeric material, each said feedblock independently connected to a multiplier die pack system comprising a series of one or more die packs, each said multiplier die pack, independently, capable of dividing said polymeric material into a plurality of layers; a roller die for receiving said plurality of multiple layers from each said series of multiplier die pack, each said roller, independently, capable of pulling said multiple layers from said roller; and said multiple layers from each said series of multiplier die pack forming a multilayer profile of said extrudates.

### BRIEF DESCRIPTION OF THE DRAWINGS

The invention will be better understood and other features and advantages will become apparent by reading the detailed description of the invention, taken together with the drawings, wherein:

FIG. 1 relates to a prior art general concept of polymer layer multiplication;

FIG. 2 relates to a prior art, the first generation CLIPS layer multiplier flow channel (left), redesigned (second generation) CLIPS layer multiplier flow channel (right);

FIG. 3 relates to viscoelasticity levels in multilayer co-extrusion; typical polymers outline within box;

FIG. 4 a graph illustrating the pressure drop reduction as a result of geometric redesign

FIG. 5 relates to feedblock (two channels at left) and single multiplier die (four separate channels at center/right) flow domain;

FIG. 6 is a graph illustrating storage and loss moduli for various compounds;

FIG. 7 is a graph illustrating complex viscosity for various compounds, wherein actual extrusion rates are closely displayed in the region of the square;

FIG. 8 relates to a velocity profile of the rheologically matched system at start of multiplier die (left), near center of multiplier die (center), and at exit of the multiplier die (right);

FIG. 9 relates to a velocity profile of the rheologically mismatched system at start of multiplier die (left), near center of multiplier die (center), and at exit of the multiplier die (right), the velocity is higher at the base of the multiplier due to the lower viscosity of the butyl compound;

FIG. 10 relates to eight layer velocity profile, (two materials per four channels) at the outflow of the flow domain of the rheologically matched (right) and the rheologically mismatched (left), a fixed interface is displayed;

FIG. 11 is a graph illustrating gear pump and extrusion temperature as a function of extrudate temperature;

FIG. 12 illustrates layer quality of a rheologically matched system;

FIG. 13 illustrates layer quality of a rheologically mismatched system;

FIG. 14 is a graph illustrating layer distribution of an 8-layer system;

FIG. 15 is a graph illustrating layer distribution of a 32-layer system;

FIG. 16 illustrates one embodiment of a single die pack capable of layer multiplication of a factor of 4;

FIG. 17 illustrated one embodiment of an extruder suitable for practicing the methods of the present invention;

FIG. 18 illustrates one embodiment of a multilayer co-extrusion system of the present invention including, from right to left, an extruder, system feedblock, one layer multiplication die pack, and a roller die; and

FIG. 19 illustrates a side view of a multilayer extrudate formed from two different butyl compounds;

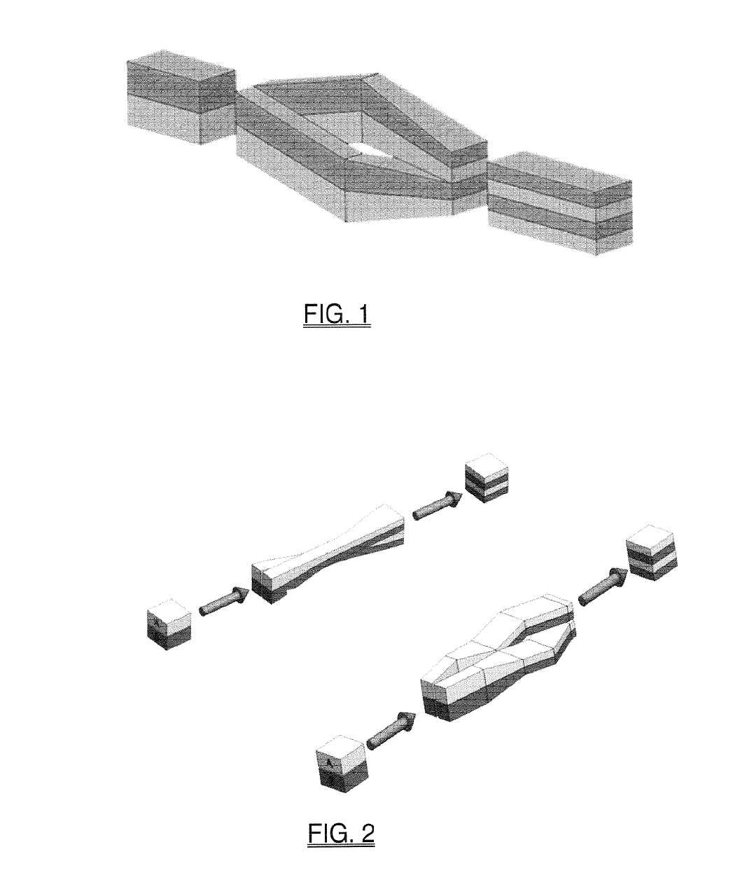

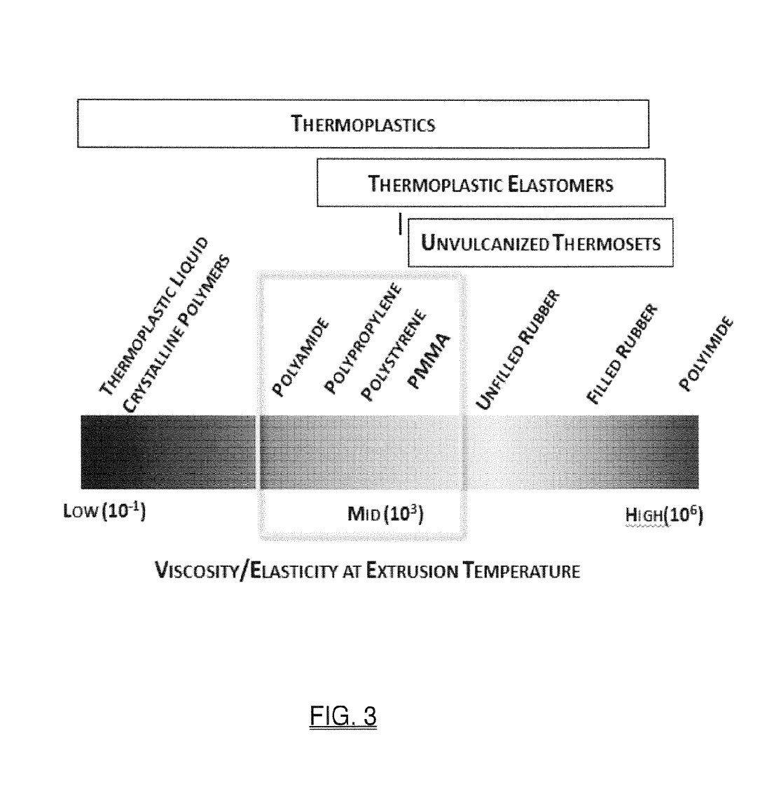

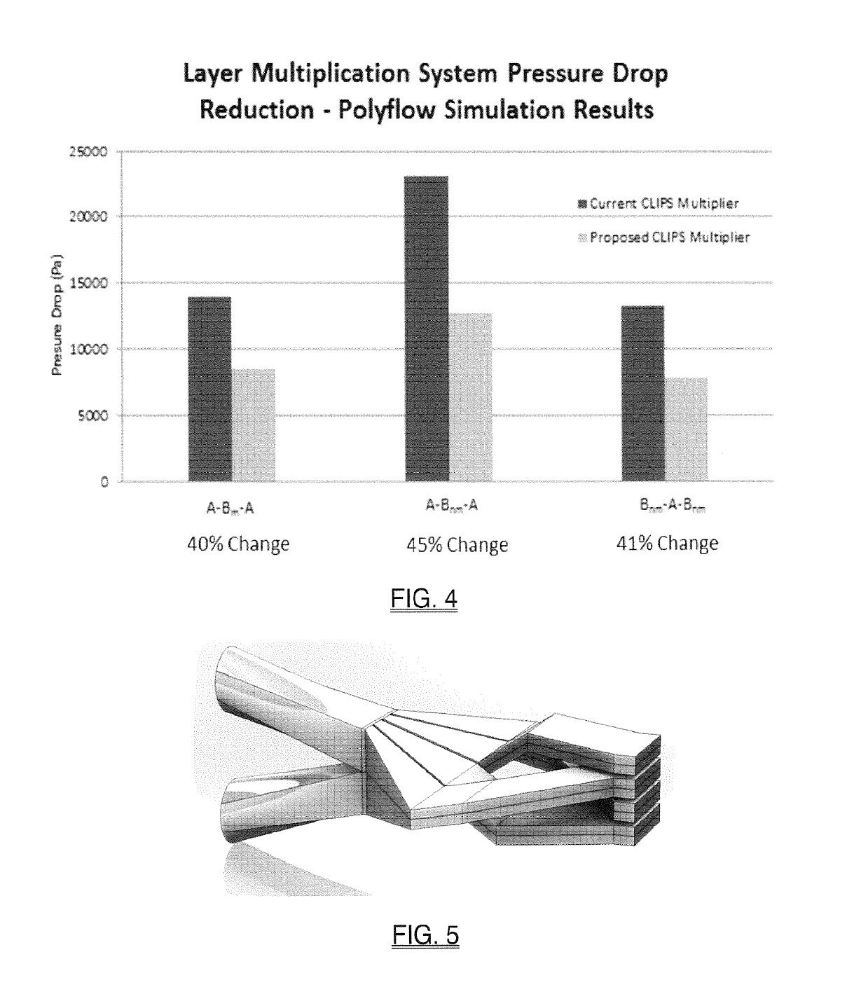

### DETAILED DESCRIPTION OF THE INVENTION

The multilayer co-extrusion system of the present invention allows various materials including high viscosity elastomer materials to be formed into multilayer extrudates or profiles processing desirable qualities. The multilayer co-extrusion system comprises two extruders which feed into gear pumps then into a feed block, one or more multiplication die packs and a roller die.

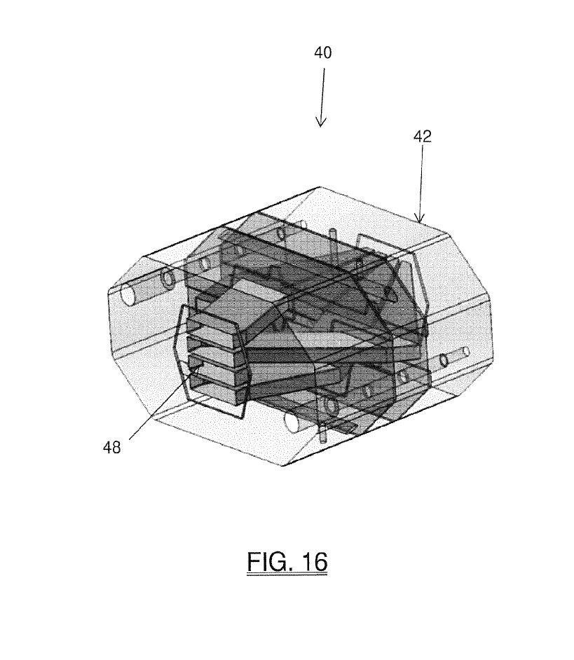

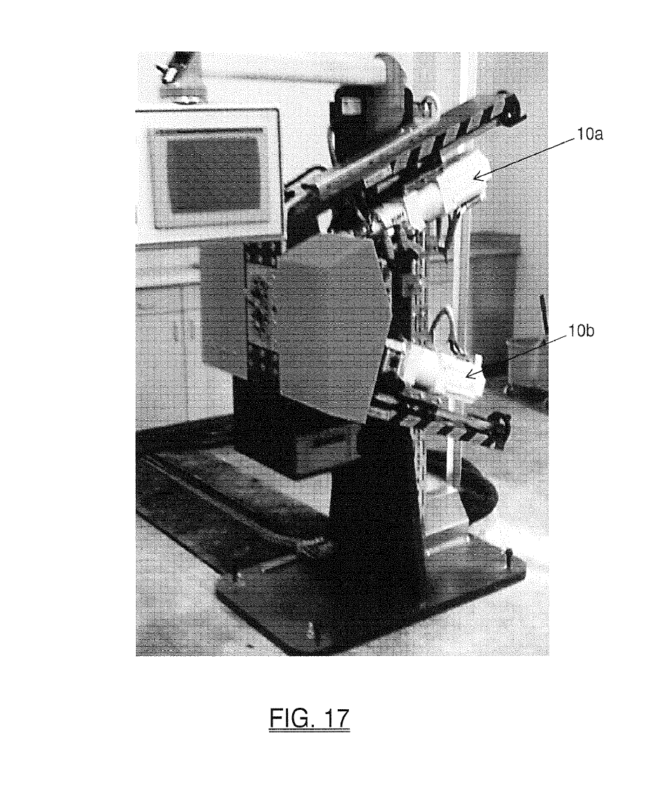

FIG. 16 relates to single die pack of the present invention that has a multiplication factor of 4. The die pack is generally indicated by the number 40 and contains inlet 42 as well as a plurality of outlets 48. Polymeric material from the feedblock is fed to lip 42, which then separates material, and this in particular embodiment into four adjacent layers.

FIG. 17 illustrates one embodiment of a co-extrusion extruder suitable for use in practicing the present invention. The co-extrusion polymeric material system of the present invention is generally indicated by the numeral 1 that comprises two separate co-extrusion extruders 10a and 10b that can be operatively connected to one or more gear pumps, not shown.

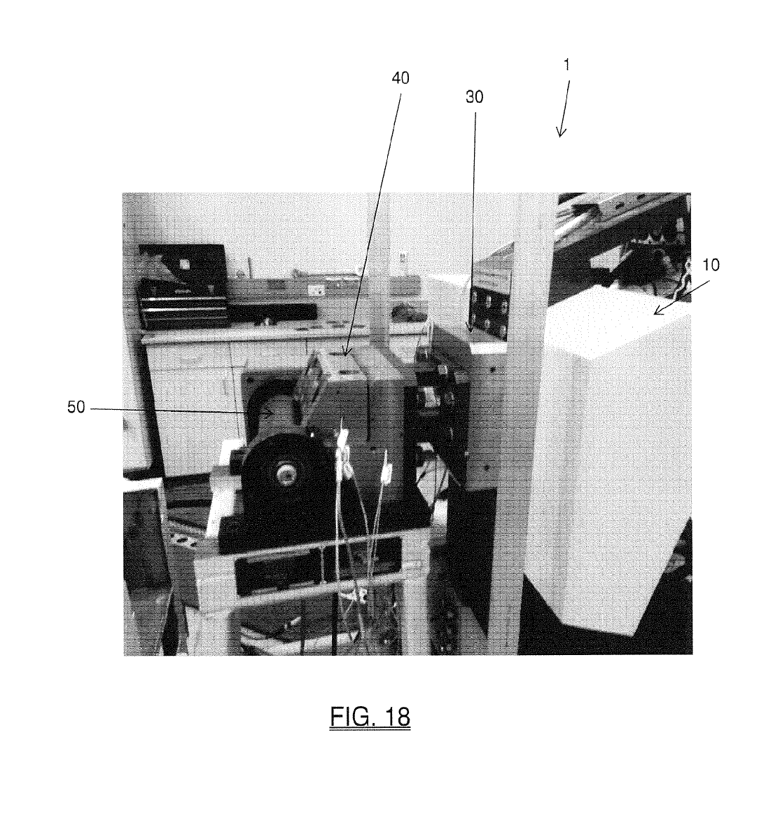

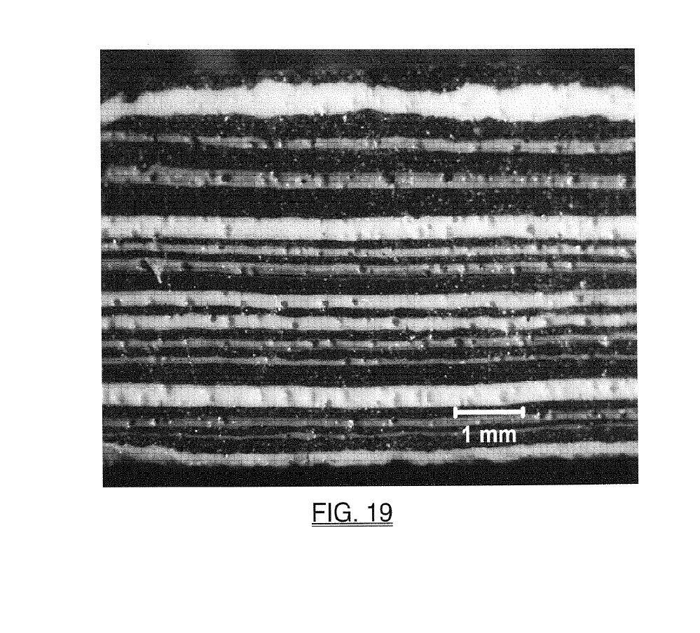

A co-extrusion polymeric material system according to the present invention is shown in FIG. 18 wherein two, or more, co-extrusion extruders each extrude polymeric material and each extrudate is sent to a separate gear pump located within extruder housing 10 that receive the same by any operative connection known to the art and to the literature. Each gear pump, independently, increases the pressure to extremely high desired pressures such as from about 10 to about 100 MPa and preferably from about 20 to about 80 MPa. Each gear pump is operatively connected to a separate feedblock 30 and, independently, feed the pressurized polymeric material thereto. Operatively connected to each feedblock 30 is a separate multiplying die pack system 40, comprising a series of one or more die packs, with each die pack, independently, at least doubling the number of layers fed thereto, with the amount of multiplying layers being a factor generally of 2. In order to reduce back pressure within feedblock 30, a roller dies 50 exists with respect to each multiplier to, independently, pull the extruded and multiple layered laminate from die blocks 40.

The polymeric materials generally comprise elastomers, unvulcanized thermosets thermoplastic elastomers, thermoplastic vulcanizates and the like well-known to the art and to the literature. Examples of suitable polymeric materials of the present invention include natural rubber, polyisoprene, styrene butadiene rubber, butyl rubber, butadiene rubber, ethylene-propylene-diene-monomer rubber, halogenated butyl rubber, various oil extended rubbers, and any combination thereof. The polymeric materials are fed to the various extruders and generally can be in any form such as granular, pellets, and the like with strips being preferred. An important aspect of the present invention is that a polymeric material can generally have a high viscosity and another polymeric material can have a lower viscosity. The advantages of the current set-up are twofold: i) It allows very high viscosity materials, i.e., viscosities generally above 10⁵, or about 6·10⁵ to about 10⁸ or about 10⁹ Pa to be layered; ii) It allows materials with viscosity mismatches of up to 10:1 and even up to 100:1 to be layered. It is not particularly suitable for low viscosity materials, although low viscosity materials can be utilized, e.g. below 10⁵, or below about 3·10⁴ or below about 10⁴ Pa. Viscosity measurements were made with a rubber process analyzer (RPA) at 100° C., 15% strain at 0.83 Hz for the uncured polymeric materials.

The various polymeric materials are fed to two, or more, extruders generally at ambient or room temperature, e.g. about 10° C. to about 30° C. or about 50° C. According to an important embodiment of the present invention, the extruder should be operated at low temperatures such as from ambient, for example about 21° C. to about 300° C. or to about 125° C.

Various co-extrusion extruders are known to those of ordinary skill in the art. One example of a commercially available co-extrusion extruder is a Shark Duplex Co-extrusion Extruder. In one embodiment, the extruder includes two single-screw extruders which feed into separate gear pumps. In one embodiment, each gear pump is capable of achieving a desired pressure for example at least about 100 MPa in one embodiment. Utilizing extruders having gear pumps capable of achieving relatively high pressures are important to achieve the desired layering of various material systems, in particular high viscosity rubber systems.

A system feedblock 30 is operatively connected to each extruder and a first multiplication die pack system is connected to the feedblock. The primary aim of the feedblock is to combine the 2 or more extrudates directly from the gear pump and extruders and act as a transition die before entering into the layer multipliers.

Each die pack 40, independently, is capable of multiplying a layer received from the feed block by a factor of 3 or 4 or more, that is, as previously noted, multiplier converts at least one layer into two layers with the broad range being from about 2 or 4. As noted, one embodiment of the multiplication die pack is illustrated in FIG. 16. Die pack inlet 42 separates a layer received from the feedblock or another die pack into four different streams or channels which each travel through the die pack to four separate outlets 48. The outlets are stacked vertically such that the exiting extrudates are arranged one on top of the other and thus form a layered profile. The four-channel multiplication die of the present invention multiplies the layers at a rate of:

N=2⁽²ⁿ⁺¹⁾, (1)

where N is the total number of layers, and n is the number of multiplication die packs.

A desired number of multiplication die packs are included in the multilayer co-extrusion system and generally range from about 1 to about 10 or more, desirably from about 1 to about 6 and preferably from about 1 to about 5.

The extrudate from the last multiplication die pack of the system is transferred from an outlet thereof to a roller die 50. The roller die includes a roller portion that pulls on the material, relieving pressure built up in a system. The die portion of the roller die aids in shaping the final profile of the extrudate. The roller die may include a coating on a surface thereof that is adapted to contact the extrudate in order to aid in the removal of extrudate therefrom.

An important aspect of the present invention, the multilayer co-extrusion system of the invention is constructed for cold-feed extrusion. Relatively long and cold material strips are utilized. The strips can be of any desired length, depending upon the particular application. The strips of the materials to be extruded are fed to a warm extruder having a temperature as previously noted that ranges generally from about room temperature or about 21° C. to about 100° C., or 300° C. where they are extruded. Other known multilayer co-extrusion systems utilize small pellets or granules of material that must be melted at a relatively high temperature in order to provide for material flow at a low viscosity.

In view of the above, the methods of the present invention include the steps of obtaining at least two different materials to be extruded, each preferably in the form of a strip of a predetermined length. The strips are fed separately into an extruder and forced through a die. The extrudates are each processed through one or more multiplying die packs that multiply an extrudate layer by a factor of 3, 4, or more. The layered material exiting the final die pack is processed utilizing a roller die which pulls on the layered material and also imparts a desired shape thereto.

FIG. 4 relates to a multiple layer or laminate produced by the present invention wherein the light colored portions relate to a low-viscosity unvulcanized rubber compound and the dark layers relate to the originally extruded high-viscosity unvulcanized rubber compound.

### Examples

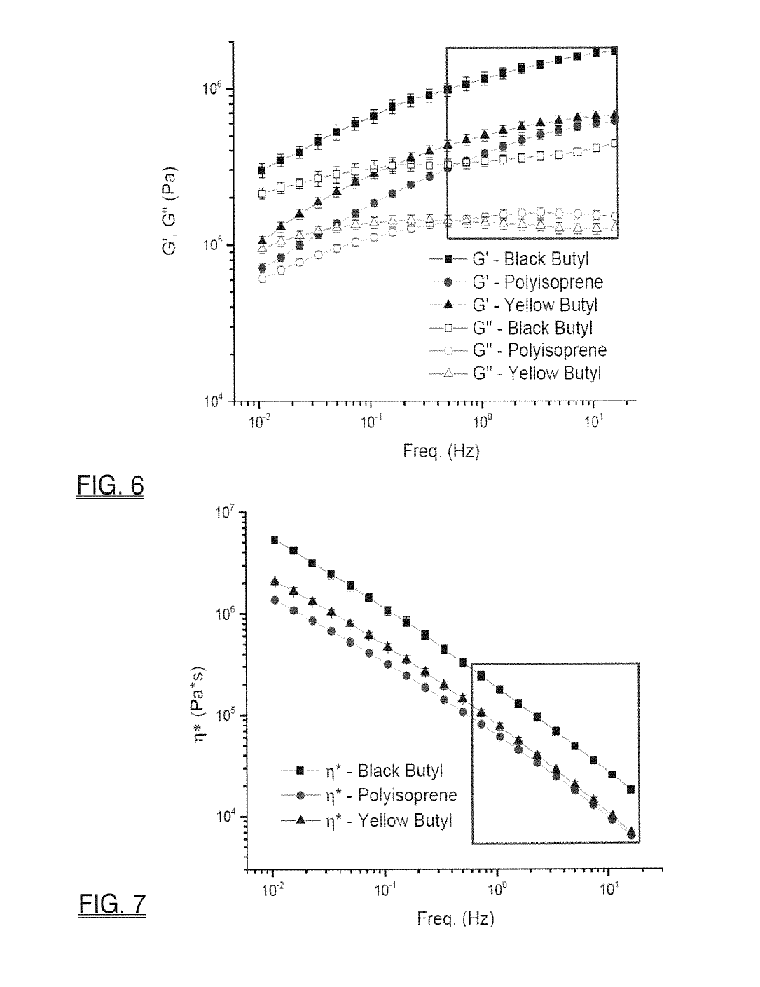

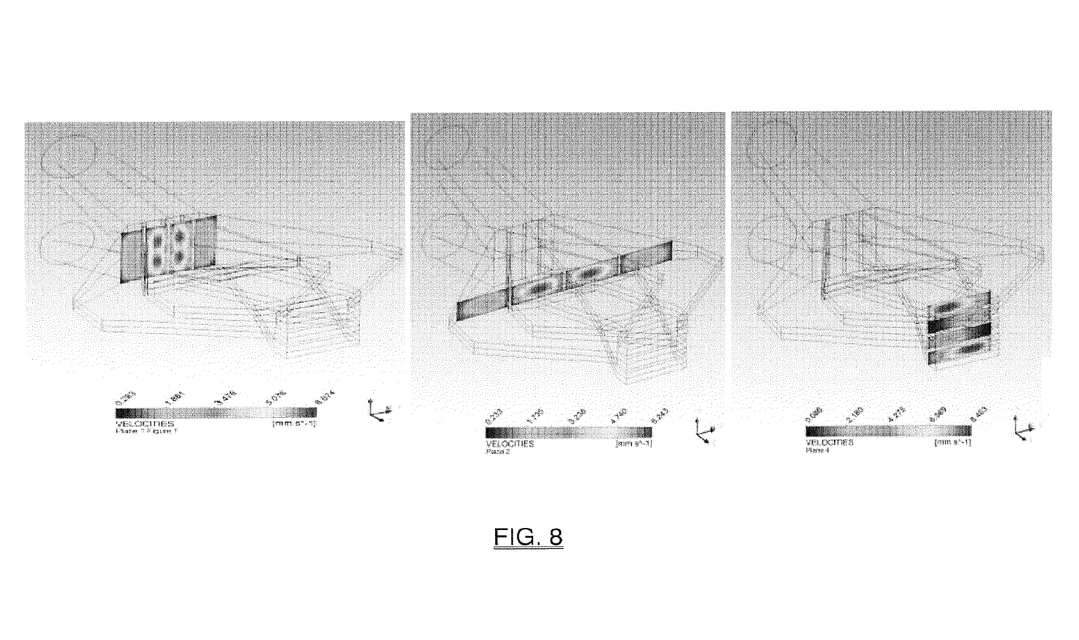

Three unvulcanized rubber systems were used for this study; two butyl rubbers (poly[isobutylene-co-isoprene]) and a polyisoprene rubber. One of the butyl rubbers as termed by ‘yellow butyl’ throughout is compounded with silica, clay, and a yellow pigment. The other butyl rubber is a carbon black based compound. Each of the rubbers used in this work were first characterized by oscillatory shear using a Haake MARS III rotational rheometer. An 8 mm parallel plate system and an electrically heated bottom plate were used for all shear experiments. Oscillatory stress sweeps were first performed to identify the region in which the storage modulus (G′) and the loss modulus (G″) responds linearly as a function of applied shear stress. A shear stress was then chosen for each of the materials and applied during the oscillatory frequency sweeps. FIGS. 5 and 6 display G′, G″ and η* as a function of frequency. Apparent shear rates of the multilayer co-extrusion process (identified during and following co-extrusion), fall in the range of 2.6 s⁻¹ and 131 s⁻¹, depending on the sectional area and RPM conditions. After applying the Cox-Merz rule, the apparent shear rates are equivalent to 0.4 Hz to 20 Hz. concerning oscillatory shear conditions. These rates are depicted in FIGS. 5 and 6 by the box. The material system, which was identified to be a rheologically ‘matched’ system, is the yellow butyl and polyisoprene system; while the ‘mismatched’ rheological system is yellow butyl and black butyl. Both elasticity and viscosity are matched for the yellow butyl/polyisoprene system; while both elasticity and viscosity are mismatched for the yellow butyl and black butyl system.

The viscosity and elasticity ratios are shown in Table 1 below. The ratio represents either the polyisoprene or black butyl to the yellow butyl. The viscosity and elasticity ratio for the ‘matched’ pairing of compounds are 0.89 and 0.87, while the mismatched pairing has larger ratios of 2.47 and 2.44.

TABLE 1
Viscosity and elasticity ratios of the layering compounds at 5 Hz

| | Polyisoprene/Yellow butyl | Black butyl/Yellow butyl |
|---|---|---|
| | “Matched” | “Mismatched” |
| Viscosity ratio | 0.89 | 2.47 |
| Elasticity ratio | 0.87 | 2.44 |

The extrusion system was specially designed for the multilayer process and houses two single-screw extruders, which feed into separate gear pumps. The screws have a diameter of 30 mm with an L/D of 10:1. Each gear pump is capable of 80 kg/h throughput with a maximum of 50 RPM and pressures capable of 100 MPa, approximately 3× the capable pressures in typical thermoplastic co-extrusion processes. Extreme capable pressures in the developed system were crucial for the layering of the high viscosity rubber systems. Layer multiplication was performed with similar dies used in the work by Harris et. al. (2013); with the exception of rather than using a two-channel multiplication die, the dies in this system were designed with four channels thereby multiplying the layers at a rate of:

N=2⁽²ⁿ⁺¹⁾, (1)

where N is the total number of layers, and n is the number of multiplication die packs.

Following the layer multiplication dies, the continuous process altered the layered structure from a 39 mm×39 mm flow channel, into a 100 mm wide by 2.5 mm high via single roll roller die designed and manufactured specifically for this process.

For this multilayer research, processing conditions such as extruder, gear pump, and roller die temperature; and final roller die speed and geometry were not varied. The single processing condition varied to investigate layer structure was gear pump RPM. Similarly, two layering conditions were studied, an 8 layer system and a 32 layer system; developed from one die pack and two multiplication die packs, respectively.

The final product was cut for visualization of the cross-section near Tg temperatures to promote a clean cut of the sample. Cross-sectional images were taken with a digital camera, in the case of the 39 mm SQ. samples and with an Olympus optical microscope in the case of the thinner 2.5 mm thick samples.

Presentation of Results

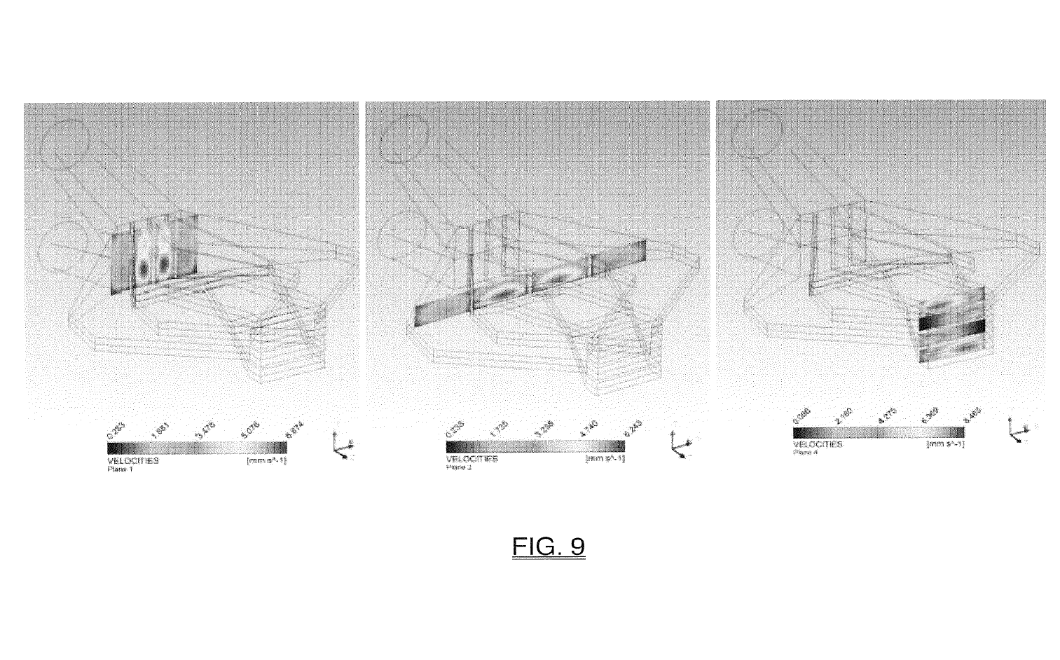

Two early parameters were first studied with the polyisoprene compound layered with itself, to 32 layers. FIG. 7 displays the gear pump head pressure and extrudate temperature as a function of material throughput. Head pressure was taken directly following the gear pumps, before the separate streams flow together and into the multiplication dies. Extrudate temperature was taken with an infrared temperature gun at the exit of the single roll roller die. At relatively low output, both pressure and temperature increase; however, at outputs above 50 kg/h, the material displays a constant pressure. This is the not the case for temperature, as temperature continued to elevate

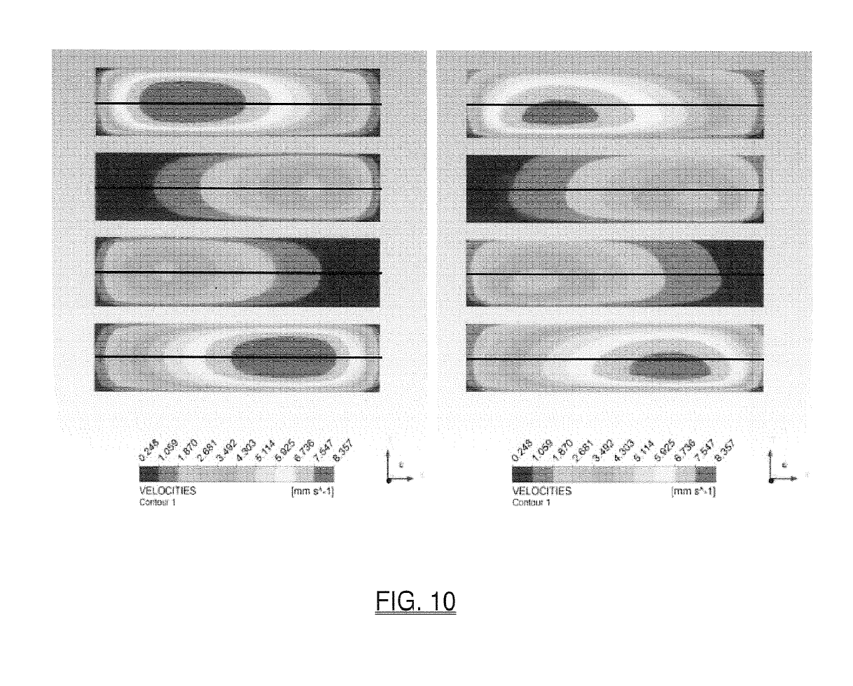

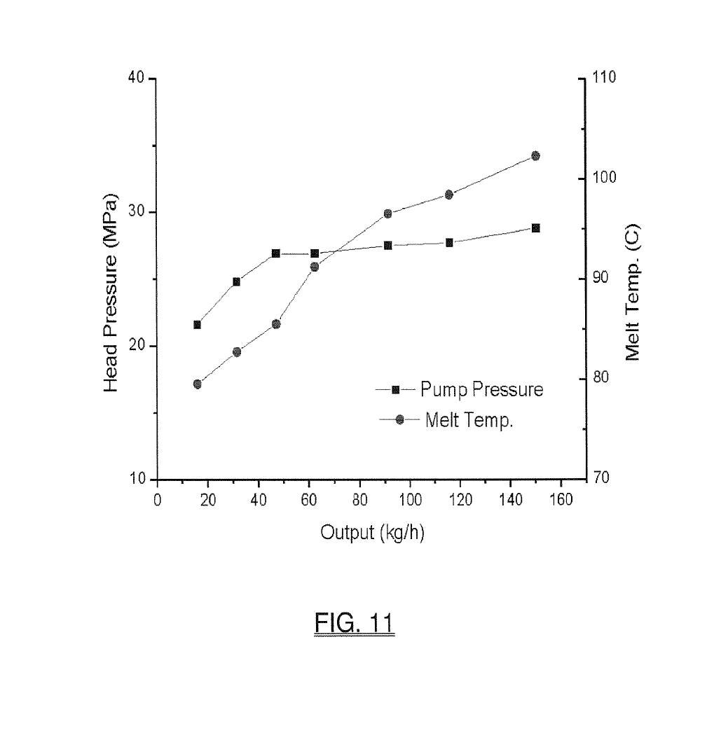

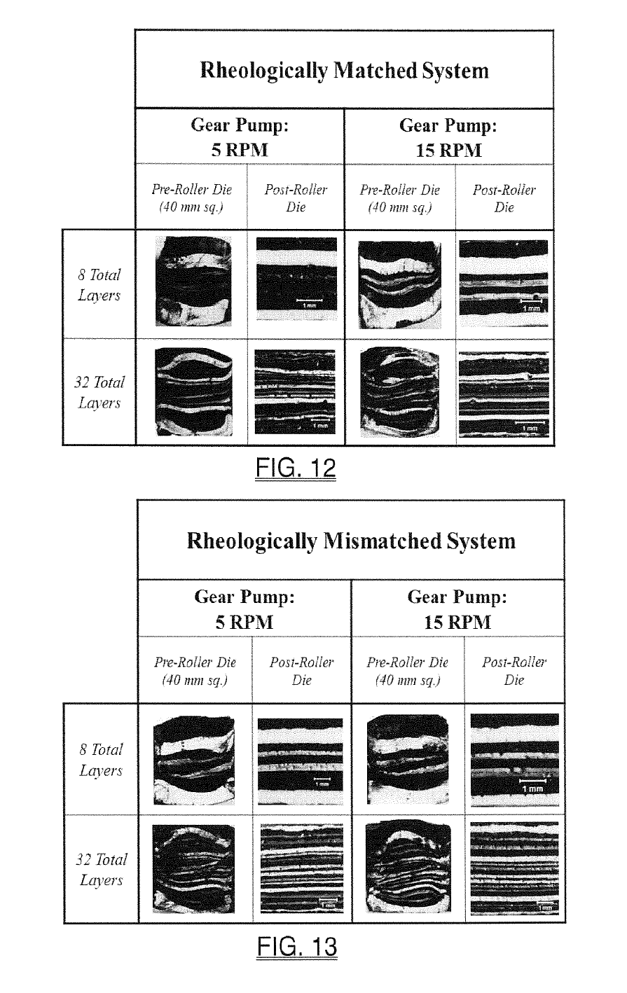

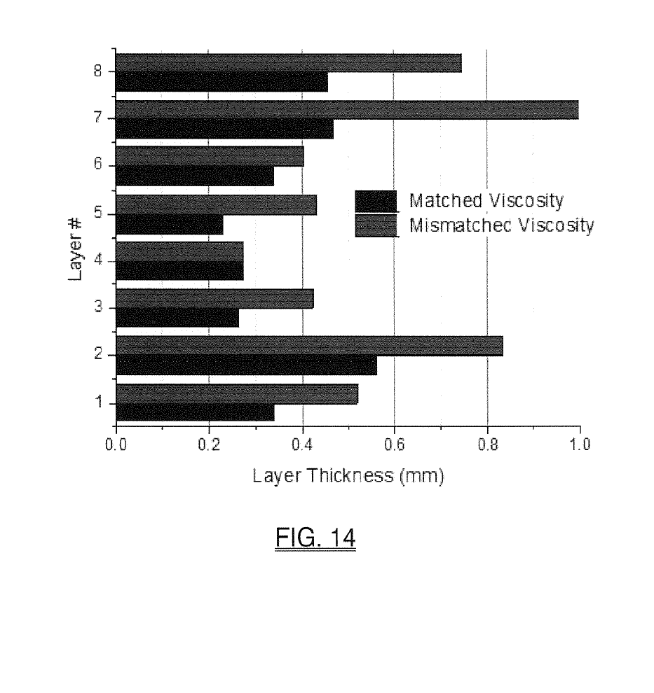

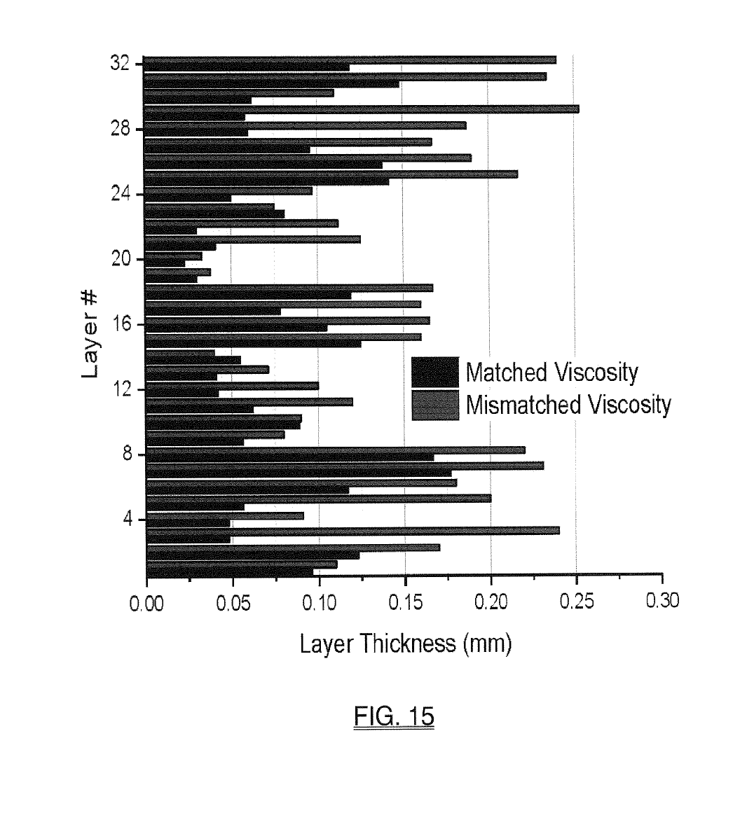

Layer quality is important for defining the effect of material properties as well as the effect which processing conditions such as gear pump RPM has on the final structure. In both FIGS. 8 and 9, the first and third columns are images taken of the layered structure directly out of the multiplication dies, pre-roller die. In these images, there is a noticeable distortion in the bottom and top layers. The dimensions of these images are 40 mm SQ. Due to the elasticity and size of these samples, accurate cross-sectional slicing was difficult to achieve. The second and fourth columns display the layered structures postroller die, when the samples have spread to the final thickness of 2.5 mm.

In the case of the rheologically matched, 8-layer systems (FIG. 8), there tends to display thicker regions in the top and bottom two layers. In the 32-layer matched system, the thicker layers are displayed every four layers.

Similarly, in FIG. 9, in the rheologically mismatched, 8-layer system, there are also thick layers on the top and bottom two layers. Also in this system, the layer non-uniformity is compounded into the 32 layers; that is, each 4 layers, there are thicker layers displayed.

To get a quantitative layer distribution, Image J analysis software was used on the second and fourth columns of FIGS. 8 and 9. The layer distribution for both matched and mismatched, 8-layer system (5 RPM pump rate) is shown in FIG. 10. Layer numbers 1, 2, 7 and 8 all display thicker layers while; the center layers are much thinner. These layer numbers correspond to the bottom and top 25% of the layered structure. The mismatched system displayed in red bars has an overall larger thickness compared to the matched system, in black.

The layer distributions for both 32-layer material systems are displayed in FIG. 11. While the bottom and top 25% of the layered structure display the thickest layers for both material systems, there also exists non-uniformity in the layered structure within the each 25%. For example, layers 1-8 have an average layer thickness greater than that of 9-16 and 17-24; however, within layers 1-8, the top and bottom 2 layers (layers 1, 2, 7, and 8) have the largest relative thickness.

Average thickness, standard deviation, and the coefficient of variation of each layered system are displayed in Table 2 below. The overall average layer thickness is much larger in the mismatched system. Similarly, though a 2.5 mm thickness die was used for the 32 layers, there exists a large amount of die swell; specifically, nearly double thick on the mismatched rheology system. The standard deviation of the layer thickness is large, as displayed in FIGS. 8-11; and the relative amounts are quantitatively displayed by the variation coefficient. Noteworthy, the mismatched system has a more stable variation coefficient, 44% moving from 8 layers into 32 layers; whereas the matched system has more extreme values, 32% and 51%.

TABLE 2
Average, standard deviation, and variation coefficient

| | Polyisoprene/Yellow | | Black butyl/Yellow butyl | |
|---|---|---|---|---|
| | butyl “Matched” | | “Mismatched” | |
| | 8 layers | 32 layers | 8 layers | 32 layers |
| Mean (mm) | 0.366 | 0.084 | 0.581 | 0.146 |
| Std. Dev. (mm) | 0.117 | 0.043 | 0.256 | 0.065 |
| Variation Coefficient | 32% | 51% | 44% | 44% |

Discussion of Results

Two phenomena commonly seen in polymer processing are displayed in FIG. 7. First, the head pressure steadily rising then leveling off after 50 kg/h is attributed to slip along the die wall. This will play an important role in future studies when an increased quantity of layers is attempted. The approximate 27 MPa of head pressure is encouraging to the authors in that the system is using ⅓ of the maximum gear pump pressure with two multiplication die packs. This data insinuates that an additional 4 die packs are possible, resulting in 8,192 total layers; using formula (1) above. Extrudate temperature is important for rubber compounds and is commonly measured for processing due to chances of vulcanization. Shear induced heating caused by friction within the polymeric material is the primary reason for the steady increase of temperature in FIG. 7. Temperatures in the region displayed here are not of concern and are well below vulcanization temperature.

The layer distortion of the extrudate in columns 1 and 3 in both FIGS. 8 and 9 are attributed to the high levels of second normal stress differences. For this reason, the square 39×39 mm channel had a large amount of die swell contained in the extrudate.

Interestingly, the overall quality of the mismatched system is lower than that of the rheologically matched system. One explanation to this is the completing viscoelastic properties in the mismatched system; i.e. the black butyl in the mismatched system has a larger storage modulus and viscosity compared to the polyisoprene compound. Here, the black butyl acts as a rigid structure and the lower viscoelastic yellow butyl complies. Traditionally, the quality of a matched rheological system would be higher than that of a mismatched system; however, multilayer co-extrusion of highly elastic and highly viscous compounds does not have a historical precedence.

This evidence of a more stable layer structure with a mismatched rheological system is confirmed from the data in Table 2, derived from FIGS. 10 and 11. The variation coefficient is larger for the mismatched system than that of the matched system.

While in accordance with the patent statutes the best mode and preferred embodiment have been set forth, the scope of the invention is not limited thereto, but rather by the scope of the attached claims.

What is claimed is:

1. A method for co-extruding multiple layers of a polymeric material, comprising the steps of:
providing a plurality of polymeric materials;
providing at least two extruders, each said extruder, independently, receiving said polymeric materials and extruding said polymeric material, independently, at a temperature of less than about 300° C.;
providing a gear pump for each said extruded polymeric material and, independently, applying high pressure to each said extrudate;
providing a feedblock for each said gear pump for receiving said pressurized polymeric material, each said feedblock, independently, connected to a multiplier die pack system comprising a series of one or more said die packs, each said multiplier die pack, independently, capable of dividing said polymeric material into a plurality of layers;
providing a roller die for receiving said plurality of multiple layers from each said series of multiplier die pack and, independently, pulling said plurality of multiple layers from said roller; and
combining said multiple layers from said die packs and forming a multilayer profile of said extrudates.

2. The method of claim 1, wherein at least one of said extruders receives a polymeric material having a high viscosity, and optionally at least one of said extruders receives a low viscosity polymeric material.

3. The method of claim 1, wherein each said gear pump, independently, is capable of pressurizing said polymeric material to a pressure of from about 10 to about 100 MPa.

4. The method of claim 3, wherein said high viscosity polymeric material, independently, is above 10⁵ to about 10⁹ Pa.

5. The method of claim 4, wherein said polymeric materials have a mismatched viscosity ratio of up to 100:1.

6. The method of claim 5, wherein, independently, the number of said multiplier die packs in said die pack system is from about 1 to about 10, and wherein each said multiple die pack, independently, has a multiplying factor of from 2 to about 4.

7. The method of claim 1, wherein said polymeric material is in the form of strips or granules, or pellets.

8. The method of claim 6, wherein each said extruder, independently, extrudes at a temperature of from about 21° C. to about 125° C.

9. The method of claim 3, wherein each said gear pump pressure, independently, is from about 20 to about 80 MPa and wherein said high viscosity is from above 10⁵ to about 10⁸ Pa, and wherein when said low viscosity polymeric material is utilized, the viscosity thereof is below 10⁵ Pa.

10. A system for co-extruding multiple layers of a polymeric material, comprising:
a plurality of polymeric materials;
at least two extruders, each said extruder, independently, capable of receiving said polymeric materials and, independently, extruding said polymeric material at a temperature of less than about 300° C.;
a gear pump for each said extruded polymeric material, each said gear pump capable of, independently, applying high pressure to said extruded polymeric material;
a feedblock for each said gear pump for receiving said pressurized polymeric material, each said feedblock independently connected to a multiplier die pack system comprising a series of one or more die packs, each said multiplier die pack, independently, capable of dividing said polymeric material into a plurality of layers;
a roller die for receiving said plurality of multiple layers from each said series of multiplier die pack, each said roller, independently, capable of pulling said multiple layers from said roller; and
said multiple layers from each said series of multiplier die pack forming a multilayer profile of said extrudates.

11. The system of claim 10, wherein at least one of said extruders receives a polymeric material having a high viscosity, and optionally at least one of said extruders receives a low viscosity polymeric material.

12. The system of claim 11, wherein each said gear pump, independently, is capable of pressurizing said polymeric material to the pressure of from about 10 to about 100 MPa.

13. The system of claim 12, wherein said high viscosity polymeric material, independently, is above 10⁵ to about 10⁹ Pa.

14. The system of claim 13, wherein said polymeric materials have a mismatched viscosity of up to 100:1.

15. The system of claim 14, wherein, independently, the number of said multiplier die packs in said die pack system is from about 1 to about 10, and wherein each said multiple die pack, independently, has a multiplying factor of from 2 to about 4.

16. The system of claim 10, wherein said polymeric material is in the form of a strip, granules, or pellets.

17. The system of claim 15, wherein each said extruder, independently, extrudes at a temperature of from about 21° C. to about 125° C.

18. The system of claim 12, wherein each said gear pump pressure, independently, is from about 20 to about 80 MPa and wherein said high viscosity is from above 10⁵ to about 10⁸ MPa, and wherein when said low viscosity polymeric material is utilized, the viscosity thereof is below 10⁵ Pa.
